(19) United States
(12) Patent Application Publication
(10) Pub. No.: US 2018/0072236 A1
(43) Pub. Date: Mar. 15, 2018

(54) INTEGRATED DEPLOYABLE BIKE RACK ASSEMBLY FOR A MOTOR VEHICLE

(71) Applicant: FORD GLOBAL TECHNOLOGIES, LLC, Dearborn, MI (US)

(72) Inventors: Claudio Alb Clamont Bello, Santa Fe (MX); Uzziel Alcantara, Del. Benito Juarez (MX); Luis Pablo Rivera Paredes, Alvaro Obregon (MX)

(21) Appl. No.: 15/260,970

(22) Filed: Sep. 9, 2016

(51) Int. Cl. B60R 9/10; B60R 9/06

(52) U.S. Cl. CPC B60R 9/10; B60R 9/06

(57) ABSTRACT

A deployable bike rack assembly is provided for a motor vehicle. That deployable bike rack assembly includes a closure, an access panel carried on the closure, a first bike rack support and a second bike rack support. The two bike rack supports are pivotally connected and displaceable between stowed and deployed positions. The access panel is closed to conceal the bike rack supports in the stowed position and opened to allow deployment of the bike rack supports into a position for use.

### TECHNICAL FIELD

This document relates generally to the motor vehicle equipment field and, more particularly, to a deployable bike rack assembly that is fully integrated into a motor vehicle. Such a bike rack assembly is readily available for deployment and use in holding one or more bicycles while also being readily concealable within the aesthetic surfaces of the motor vehicle when not in use.

### BACKGROUND

Many motor vehicle owners enjoy riding bicycles. Many of these owners also transport those bicycles with their motor vehicles.

Toward this end, most motor vehicle owners purchase aftermarket bike racks. Often times these bike racks must be installed on the motor vehicle each time they are used. Such aftermarket bike racks also have a tendency to mar or damage body paint when repeatedly installed and removed from the motor vehicle. As such, they are not user friendly. An individual must also store the bike rack when it is removed from the motor vehicle. Such a bike rack consumes storage space within the motor vehicle if stored within the motor vehicle. That can be inconvenient when seeking to carry other cargo. Alternatively, the bike rack could be stored in a garage but then it may not be with the user when needed at a remote location.

This document relates to a deployable bike rack assembly that is an integral part of the motor vehicle. Thus, the motor vehicle includes a dedicated space to stow and conceal the bike rack when not in use. Further, the bike rack is always carried with the motor vehicle and available for use whenever desired. Further, repeated deployment and stowing of the bike rack assembly does not mar paint finishes or otherwise damage the motor vehicle in any way. Thus, the integral deployable bike rack assembly disclosed in this document is very user friendly and represents a significant advance in the art.

### SUMMARY

In accordance with the purposes and benefits described herein, a deployable bike rack assembly is provided for a motor vehicle. That deployable bike rack assembly comprises a closure, an access panel carried on the closure and displaceable between a closed position and an opened position and a first bike rack support. That first bike rack support is pivotally connected by a first pivot to the closure. Further, that first bike rack support is displaceable between a first stowed position and a first deployed position.

The deployable bike rack assembly may further include a second bike rack support. That second bike rack support may be pivotally connected by a second pivot to the closure. Further, that second bike rack support may be displaceable between a second stowed position and a second deployed position.

When in the closed position, the access panel of the deployable bike rack assembly may close an internal compartment and conceal the first bike rack support in the first stowed position and the second bike rack support in the second stowed position. A third pivot may pivotally connect the access panel to the closure.

The first bike rack support may include a first attachment point and a second attachment point. The second bike rack support may include a third attachment point and a fourth attachment point. Together, the four attachment points may provide for securely holding two bicycles at one time.

The closure of the deployable bike rack assembly may comprise a lift gate of the motor vehicle. Further, the access panel may be an applique carried on the closure.

In accordance with an additional aspect, the deployable bike rack assembly for a motor vehicle may comprise a closure, an access panel pivotally connected by a pivot to the closure and a first bike rack support connected to the closure. The access panel is displaceable between a closed position and an opened position. The first bike rack support is displaceable between a first stowed position and a first deployed position.

The deployable bike rack assembly may further include a second bike rack support connected to the closure and displaceable between a second stowed position and a second deployed position.

The first bike rack support may include a first attachment point and a second attachment point. In addition, the second bike rack support may include a third attachment point and a fourth attachment point.

In some of the many possible embodiments, the closure may comprise a lift gate. Further, in some of the many possible embodiments, the access panel may comprise an applique.

In accordance with still another aspect, a method is provided for deploying a bike rack for a motor vehicle. That method comprises the steps of pivoting an applique on a lift gate into an open position and pivoting a first bike rack support into a first deployed position for holding a bicycle.

The method may further include the step of pivoting a second bike rack support into a second deployed position for holding a bicycle. Further, the method may include the step of locking the first bike rack support into the first deployed position and the second bike rack support into the second deployed position.

In the following description, there are shown and described several preferred embodiments of the deployable bike rack assembly. As it should be realized, the deployable bike rack assembly is capable of other, different embodiments and its several details are capable of modification in various, obvious aspects all without departing from the deployable bike rack assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the deployable bike rack assembly and together with the description serve to explain certain principles thereof. In the drawing figures:

FIG. 1 is a rear perspective view of a motor vehicle equipped with the integrated deployable bike rack assembly. That deployable bike rack assembly is illustrated in a stowed position with the access panel or applique closed so as to conceal the first and second bike rack supports.

FIG. 1a is a schematic cross-sectional view illustrating the deployable bike rack assembly in the position illustrated in FIG. 1.

FIG. 2 is a perspective view of the same motor vehicle illustrated in FIG. 1 but showing the deployable bike rack assembly in a deployed or use position.

FIG. 2a is a detailed cross-sectional view illustrating the deployable bike rack assembly in the position illustrated in FIG. 2. In the use position, the access panel or applique is opened and the first and second bike rack supports are displaced into the deployed positions for use.

Reference will now be made in detail to the present preferred embodiments of the deployable bike rack assembly, an example of which is illustrated in the accompanying drawing figures.

### DETAILED DESCRIPTION

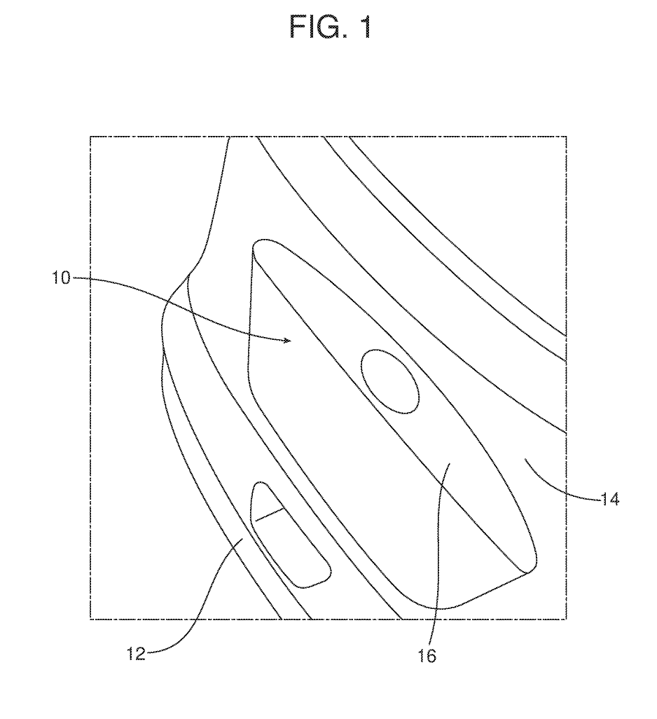

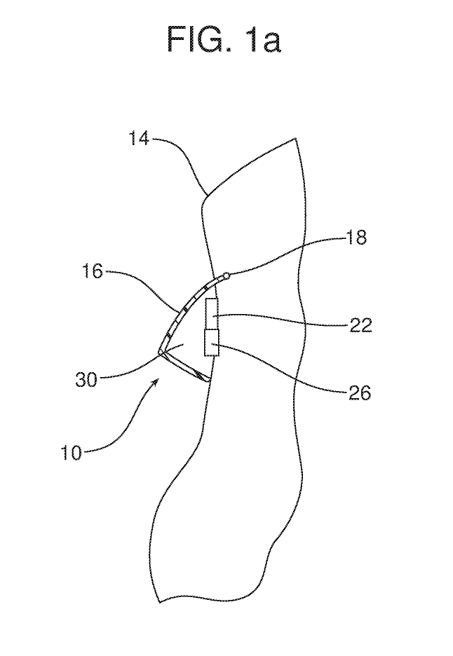

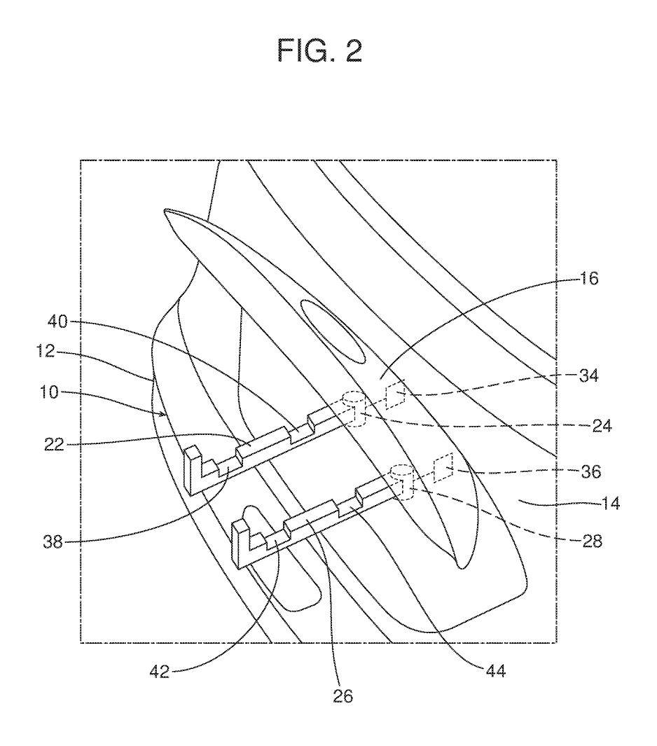

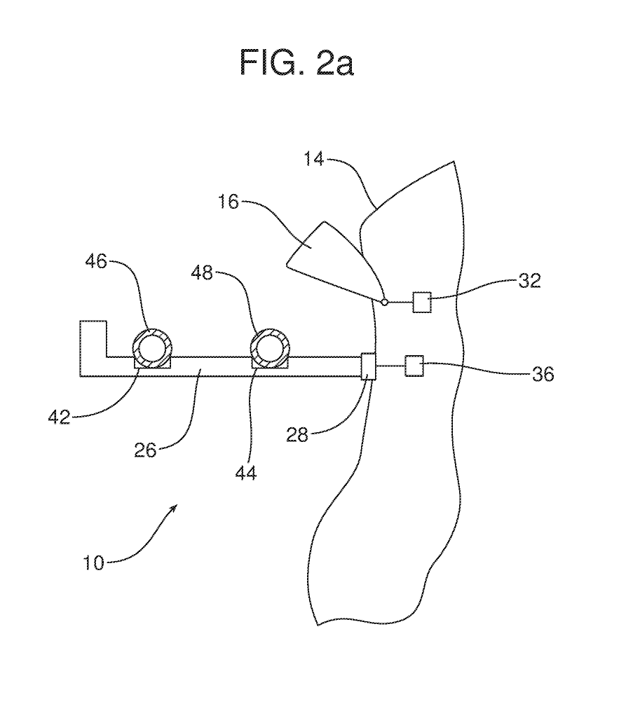

Reference is now made to FIGS. 1, 1a, 2 and 2a which illustrate the deployable bike rack assembly 10 that is integrated as a part of the motor vehicle 12. FIGS. 1 and 1a illustrate the deployable bike rack assembly 10 in a stowed position while FIGS. 2 and 2a illustrate the deployable bike rack assembly in the deployed, use position for holding one or more bicycles.

The deployable bike rack assembly 10 includes a closure 14 which in the illustrated embodiment comprises a lift gate for the motor vehicle 12. An access panel 16 is carried on the closure 14. In the illustrated embodiment, the access panel 16 comprises an applique that is mounted to the closure 14 by means of a pivot 18.

The deployable bike rack assembly 10 also includes a first bike rack support 22 that is pivotally connected by a first pivot 24 to the closure 14. Further, the deployable bike rack assembly 10 includes a second bike rack support 26 that is pivotally connected by a second pivot 28 to the closure 14.

As should be appreciated from reviewing the drawing figures, the access panel 16 is displaceable between a closed position illustrated in FIGS. 1 and 1a and an opened position illustrated in FIGS. 2 and 2a.

The first bike rack support 22 is displaceable between a first stowed position illustrated in FIGS. 1 and 1a and a first deployed position illustrated in FIGS. 2 and 2a. Similarly, the second bike rack support 26 is displaceable between a second stowed position illustrated in FIGS. 1 and 1a and a second deployed position illustrated in FIGS. 2 and 2a.

When desired by the motor vehicle operator, the first bike rack support 22 may be displaced to the first stowed position, the second bike rack support 26 may be displaced to the second stowed position and the access panel 16 may be displaced to the closed position as illustrated in FIGS. 1 and 1a. In this configuration the access panel 16 nests flush in the contours of the closure 14 effectively forming and closing an internal compartment 30 where the first bike rack support 22 and the second bike rack support 26 are concealed from view. Thus, when not in use, the deployable bike rack assembly 10 may be conveniently carried on the motor vehicle 12 with the first and second bike rack supports 22, 26 held in a dedicated internal compartment 30. Consequently, other storage space in the motor vehicle 12 remains unencumbered and available for use to carry other items while the deployable bike rack assembly 10 is maintained at all times ready for use on the motor vehicle 12.

In contrast, when the motor vehicle operator wishes to utilize the deployable bike rack assembly 10 in order to transport a bicycle, the access panel 16 is displaced to the opened position, the first bike rack support 22 is displaced to the first deployed position and the second bike rack support 26 is displaced to the second deployed position as illustrated in FIGS. 2 and 2a. A first lock, schematically illustrated at reference number 32 functions to secure or lock the access panel 16 in either the opened or the closed position. A second lock, schematically illustrated at 34, functions to secure or lock the first bike rack support 22 in the first stowed or the first deployed positions and a third lock, schematically illustrated at 36, functions to secure or lock the second bike rack support 26 in either of the second stowed or second deployed positions. Such pivot locks 32, 34, 36 are known in the art.

As best illustrated in FIGS. 2 and 2a, the first bike rack support 22 may include a first attachment point 38 and a second attachment point 40. Similarly, the second bike rack support 26 may include a third attachment point 42 and a fourth attachment point 44. In the illustrated embodiment, the first attachment point 38, second attachment point 40, third attachment point 42 and fourth attachment point 44 all comprise channels that are formed in the upper face of the respective bike rack supports 22, 26.

Accordingly, when the first bike rack support 22 and second bike rack support 26 are configured in the respective first deployed position and second deployed position, the first and second bike rack supports project rearwardly from the closure 14 with the first attachment point 38, second attachment point 40, third attachment point 42 and fourth attachment point 44 oriented upward. Thus, one may position the top tube 46 of a first bicycle in the first attachment point 38 of the first bike rack support 22 and the third attachment point 42 of the second bike rack support 26 and the top tube 48 of a second bicycle frame in the second attachment point 40 of the first bike rack support 22 and the fourth attachment point 44 of the second bike rack support 26. With the top tubes 46, 48 cradled in the attachment points 38, 40, 42, 44 it is a relatively simple matter to secure the two bicycles to the deployable bike rack assembly 10 by means of ropes, bungee cords or other appropriate tethers (not shown).

After use it is a simple matter to release the second lock 34 and displace the first bike rack support 22 from the first deployed position to the first stowed position, release the third lock 36 and displace the second bike rack support 26 from the second deployed position to the second stowed position and then release the first lock 32 and displace the access panel 16 from the opened position to the closed position thereby again concealing the first and second bike rack supports within the internal compartment 30.

Consistent with the above description, a method is also provided for deploying a bike rack assembly 10 for a motor vehicle 12. That method includes the step of pivoting an access panel or applique 16 into an opened position. In addition, the method includes the step of pivoting the first bike rack support 22 into a first deployed position for holding a bicycle.

Still further, the method may include the step of pivoting the second bike rack support 26 into a second deployed position for holding a bicycle. In addition, the method may also include the step of locking the first bike rack support 22 into the first deployed position and the second bike rack support 26 into the second deployed position.

The foregoing has been presented for purposes of illustration and description. It is not intended to be exhaustive or to limit the embodiments to the precise form disclosed. Obvious modifications and variations are possible in light of the above teachings. For example, in the illustrated embodiment, the first bike rack support 22 includes two attachment points 38, 40 while the second bike rack support 26 includes two attachment points 42, 44. Between one and as many as four attachment points may be provided on each of the bike rack supports 22, 26 with the number of attachment points corresponding to the number of bicycles that may be supported by the deployable bike rack assembly 10. Further, in the illustrated embodiment, the attachment points 38, 40, 42, 44 comprise channels that are sized and shaped to cradle a top tube 46, 48 of a bicycle frame. It should be appreciated that the attachment points 38, 40, 42, 44 may assume another appropriate structure if desired. All such modifications and variations are within the scope of the appended claims when interpreted in accordance with the breadth to which they are fairly, legally and equitably entitled.

What is claimed:

1. A deployable bike rack assembly for a motor vehicle, comprising:
a closure;
an access panel carried on said closure and displaceable between a closed position and an opened position; and
a first bike rack support pivotally connected by a first pivot to said closure and displaceable between a first stowed position and a first deployed position.

2. The deployable bike rack assembly of claim 1, further including a second bike rack support pivotally connected by a second pivot to said closure and displaceable between a second stowed position and a second deployed position.

3. The deployable bike rack assembly of claim 2, wherein said access panel in said closed position closes an internal compartment and conceals said first bike rack support in said first stowed position and said second bike rack support in said second stowed position.

4. The deployable bike rack assembly of claim 3, further including a third pivot pivotally connecting said access panel to said closure.

5. The deployable bike rack assembly of claim 4, wherein said first bike rack support includes a first attachment point and a second attachment point.

6. The deployable bike rack assembly of claim 5, wherein said second bike rack support includes a third attachment point and a fourth attachment point.

7. The deployable bike rack assembly of claim 6, wherein said closure is a lift gate.

8. The deployable bike rack assembly of claim 7, wherein said access panel is an applique.

9. The deployable bike rack assembly of claim 1, further including a third pivot pivotally connecting said access panel to said closure.

10. The deployable bike rack assembly of claim 1, wherein said closure is a lift gate.

11. The deployable bike rack assembly of claim 10, wherein said access panel is an applique.

12. A deployable bike rack assembly for a motor vehicle, comprising:
a closure;
an access panel pivotally connected by a pivot to said closure and displaceable between a closed position and an opened position; and
a first bike rack support connected to said closure and displaceable between a first stowed position and a first deployed position.

13. The deployable bike rack assembly of claim 12, further including a second bike rack support connected to said closure and displaceable between a second stowed position and a second deployed position.

14. The deployable bike rack assembly of claim 13, wherein said first bike rack support includes a first attachment point and a second attachment point.

15. The deployable bike rack assembly of claim 14, wherein said second bike rack support includes a third attachment point and a fourth attachment point.

16. The deployable bike rack assembly of claim 15, wherein said closure is a lift gate.

17. The deployable bike rack assembly of claim 16, wherein said access panel is an applique.

18. A method of deploying a bike rack assembly for a motor vehicle, comprising:
pivoting an applique on a lift gate into an opened position; and
pivoting a first bike rack support into a first deployed position for holding a first bicycle.

19. The method of claim 18, further including pivoting a second bike rack support into a second deployed position for holding a second bicycle.

20. The method of claim 19, further including locking said first bike rack support into said first deployed position and said second bike rack support into said second deployed position.
